(19) United States
(12) Patent Application Publication
(10) Pub. No.: US 2016/0162818 A1
(43) Pub. Date: Jun. 9, 2016

(54) SYSTEM AND METHOD FOR RECOMMENDING DATA ANALYSIS SERVICES

(71) Applicant: Electronics and Telecommunications Research Institute, Daejeon (KR)

(72) Inventors: Tai-Yeon KU, Daejeon (KR); Hee-Sun WON, Daejeon (KR)

(21) Appl. No.: 14/861,162

(22) Filed: Sep. 22, 2015

(30) Foreign Application Priority Data
Dec. 9, 2014 (KR) 10-2014-0175650

(51) Int. Cl. G06Q 10/06

(52) U.S. Cl. CPC G06Q 10/0633

(57) ABSTRACT

A system for recommending data analysis services is provided. The system comprises: a service catalog storing a list of analysis services; a data catalog storing a list of data of targets for analysis; an algorithm catalog storing a list of analysis algorithms; an interactive analytic tool receiving a user requirement in a word form; an analysis helper receiving the user requirement and extracting an analysis service corresponding to the user requirement from the service catalog; an analysis job generator receiving the user requirement, extracting data and an analysis algorithm corresponding to the user requirement from the data catalog and the algorithm catalog, respectively, and defining the extracted data and the extracted analysis algorithm to one job to generate a job, wherein the analysis job generator transmits the generated job to the analysis helper to deliver the job as recommendation analysis service information to a user through the interactive analytic tool.

### CROSS REFERENCE TO RELATED APPLICATION

This application claims priority to and the benefit of Korean Patent Application No. 10-2014-0175650, filed on Dec. 9, 2014, entitled “System and method for recommending data analysis services”, which is hereby incorporated by reference in its entirety into this application.

### BACKGROUND OF THE INVENTION

1. Technical Field

Exemplary embodiments of the present invention relate to a system and a method for recommending data analysis services.

2. Description of the Related Art

An analytics market using big data is dualized into a data market of which data is provided by data owners and an analysis algorithm market for analyzing the data. A data owner and an analysis algorithm owner should be connected to perform a big data analysis for commercial or academic purposes to provide analysis result from the data. However, it is the fact that an analyst has not enough data which is used for the analysis algorithm and a data owner cannot efficiently utilize the owned data due to absence of a device connecting the data owner and the analysis algorithm owner.

Recently, a data market, an analysis algorithm market and the like have been loomed in response to developments in a big data platform field based on the hadoop (High-Availability Distributed Object-Oriented Platform). Many big data platform techniques have been tried to interconnect between data and an analysis algorithm but it is not still visualized since there is no standardized method yet. Data, that individuals, businesses and public institutions have, has not been systemically and institutionally utilized for personal information protection. Many data analysis algorithms and methods have been introduced technically but data owners have to be familiar with such intricate analysis methods or do not know how to utilize it. As a result, such valuable data becomes disappeared. Thus, various methods for utilizing data have been introduced and big data platform technics have been developed to resolve such problems but they are still only for professional users.

### SUMMARY OF THE INVENTION

The present invention is to provide a system and a method for recommending data analysis services which is able to recommend data corresponding to a user requirement and an analysis algorithm which is able to analyze the data and let an analysis service selected by the user among a plurality of analysis services be automatically performed in a big data platform.

According to an aspect of the present invention, there is provided a system for recommending data analysis services.

A system for recommending data analysis services according to an embodiment of the present invention may comprise: a service catalog configured to store a list of analysis services; a data catalog configured to store a list of data of targets for analysis; an algorithm catalog configured to store a list of analysis algorithms; an interactive analytic tool configured to receive a user requirement in a word or sentence form; an analysis helper configured to receive the user requirement and extract an analysis service corresponding to the user requirement from the service catalog; an analysis job generator configured to receive the user requirement, extract data and an analysis algorithm corresponding to the user requirement from the data catalog and the algorithm catalog, respectively, and define the extracted data and the extracted analysis algorithm to one job to generate a job, wherein the analysis job generator transmits the generated job to the analysis helper to deliver the job as recommendation analysis service information to a user through the interactive analytic tool.

The interactive analytic tool may convert the received user requirement into a keyword form through a parsing process.

The analysis job generator may extract the analysis algorithm based on type and attribute information of the extracted data and the user requirement.

The analysis job generator may include input and output variables and algorithm variables into the defined job to connect the data and the analysis algorithm with the job.

The system for recommending data analysis services may further comprise a workflow generator configured to receive the job to generate analysis information; and a rule engine configured to receive and accumulate the analysis information, generate a workflow corresponding to the user requirement based on the accumulated analysis information, and transmit the generated workflow to the analysis helper to further deliver the workflow as recommendation analysis service information to the user through the interactive analytic tool.

The workflow generator may generate the analysis information comprising big data system information and the user requirement in the keyword form by using information of the data and analysis algorithm included in the received job.

The rule engine may register the accumulated analysis information as a reference index required for generating a workflow and generate a workflow corresponding to current user requirement based on the accumulated analysis information and study information of the analysis information.

When any one of the recommendation analysis service information is selected by the user, the selected recommendation analysis service is performed for an analysis operation in a big data platform.

According to another aspect of the present invention, there is provide a method for recommending data analysis services which is performed in a system for recommending data analysis services.

A method for recommending data analysis services according to an embodiment of the present invention may comprise: receiving a user requirement in a word or sentence form; receiving the user requirement and extracting an analysis service corresponding to the user requirement from a service catalog, in which the service catalog stores a list of analysis services; receiving the user requirement and extracting data and an analysis algorithm corresponding to the user requirement from a data catalog and an algorithm catalog, respectively, in which the data catalog stores a list of data of targets for analysis and the algorithm catalog stores a list of analysis algorithms; defining the extracted data and the extracted analysis algorithm to one job to generate a job; and transmitting the generated job as recommendation analysis service information to a user.

The step for receiving a user requirement may comprise converting the received user requirement into a keyword form through a parsing process.

The step for extracting data and an analysis algorithm corresponding to the user requirement may comprise extracting the analysis algorithm based on type and attribute information of the extracted data and the user requirement.

The step for generating a job may comprise including input and output variables and algorithm variables into the defined job to connect the data and the analysis algorithm with the job.

The method for recommending data analysis services may further comprise receiving the job to generate analysis information; receiving and accumulating the analysis information; generating a workflow corresponding to the user requirement based on the accumulated analysis information; and transmitting the generated workflow as recommendation analysis service information to the user.

The step for generating analysis information may comprise generating the analysis information comprising big data system information and the user requirement in the keyword form by using information of the data and analysis algorithm included in the received job.

The step for generating a workflow may comprise registering the accumulated analysis information as a reference index required for generating a workflow, and generating a workflow corresponding to current user requirement based on the accumulated analysis information and study information of the analysis information.

The present invention allows to recommend data corresponding to a user requirement and an analysis algorithm which is able to analyze the data and let an analysis service selected by the user among a plurality of analysis services be automatically performed in a big data platform.

### BRIEF DESCRIPTION OF DRAWINGS

FIG. 1 is a schematic view illustrating configuration of a system for recommending data analysis services.

FIG. 2 is a flowchart illustrating a method for recommending data analysis services.

FIG. 3 is a schematic view to explain the method for recommending data analysis services of FIG. 2.

FIG. 4 is a method for providing an analysis service based on the selection of a recommendation analysis service.

FIG. 5 illustrates configuration of a log analysis system.

### DESCRIPTION OF THE EXEMPLARY EMBODIMENTS

The present invention will be described with reference to particular embodiments along with the accompanying drawings. However, it is to be appreciated that various changes and modifications may be made. The exemplary embodiments disclosed in the present invention do not limit but describe the spirit of the present invention, and the scope of the present invention is not limited by the exemplary embodiments. The scope of the present invention should be interpreted that all spirits equivalent to the following claims fall with the scope of the present invention.

Throughout the description of the present invention, when describing a certain technology is determined to evade the point of the present invention, the pertinent detailed description will be omitted. While such terms as “first” and “second,” etc., may be used to describe various components, such components must not be limited to the above terms. The above terms are used only to distinguish one component from another.

When one element is described as being “connected” or “accessed” to another element, it shall be construed as being connected or accessed to the other element directly but also as possibly having another element in between.

Exemplary embodiments of the invention will be described below in more detail with reference to the accompanying drawings, in which those components are rendered the same reference number that are the same or are in correspondence, regardless of the figure number.

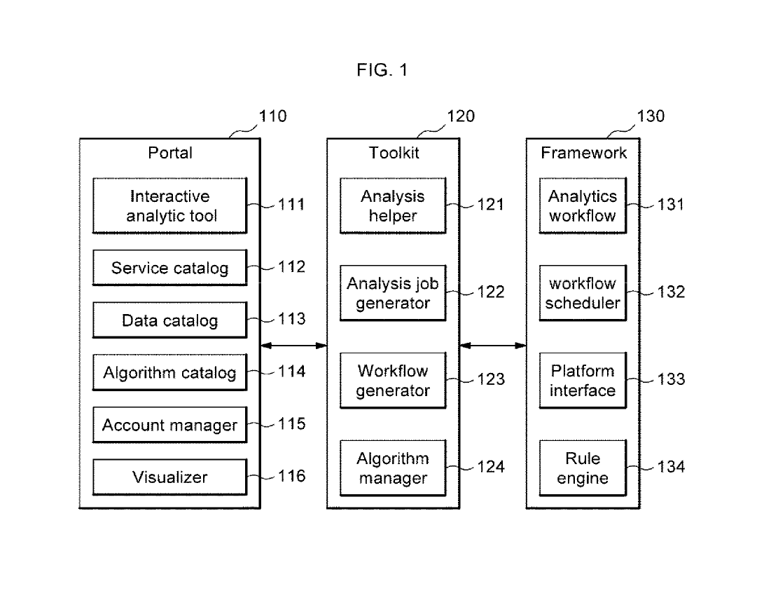

FIG. 1 is a schematic view illustrating configuration of a system for recommending data analysis services.

Referring to FIG. 1, a system for recommending data analysis services has a hierarchy structure comprising a portal 110, a toolkit 120 and a framework 130.

The portal 110 may have configuration which shows to a user to select a menu according to a user requirement, and comprise an interactive analytic tool 111, a service catalog 112, a data catalog 113, an algorithm catalog 114, an account manager 115, and a visualizer 116.

The toolkit 120 may comprise an analysis helper 121, an analysis job generator 122, a workflow generator 123, and an algorithm manager 124.

The framework 130 may comprise an analytics workflow 131, a workflow scheduler 132, a platform interface 133, and a rule engine 134.

The interactive analytic tool 111 may receive a user requirement in a word or sentence form and convert the received user requirement into a keyword form through a parsing process. The user may reflect his/her requirement using the interactive analytic tool 111. The interactive analytic tool 111 may transmit the user requirement in the keyword form to the analysis helper 121. The interactive analytic tool 111 may also output the transmitted information to the user.

The service catalog 112 may store a list of analysis services. For example, the service catalog 112 may interconnect with a separate database which stores analysis service information according to the list of analysis services.

The data catalog 113 may store a list of data of targets for analysis.

The algorithm catalog 114 may store a list of analysis algorithms.

For example, the data catalog 113 and the algorithm catalog 114 may store the list of data provided from the big data platform and the list of list of analysis algorithms, respectively and may interconnect with each separate database which stores data and analysis algorithms based on the lists, respectively.

The account manager 115 may generate and manage user accounts.

The visualizer 116 may visualize to display functions as menus which are provided by the interactive analytic tool 111, the service catalog 112, the data catalog 113, the algorithm catalog 114, and the account manager 115, or visualize information which is transmitted to the user.

The analysis helper 121 may extract an analysis service corresponding to the user requirement, received from the interactive analytic tool 111, from the service catalog 112. The analysis helper 121 may also transmit the user requirement in the keyword form to the analysis job generator 122.

The analysis job generator 122 may extract data and an analysis algorithm corresponding to the user requirement from the data catalog 113 and the algorithm catalog 114, respectively, based on the user requirement in the keyword form transmitted from the analysis helper 121. For example, the analysis job generator 122 may extract data corresponding to the user requirement and an analysis method (i.e., analysis algorithm) which is able to analyze the data by analyzing the data list and the analysis algorithm list stored in the data catalog 113 and the algorithm catalog 114, respectively. That is, the analysis job generator 122 may extract an analysis algorithm which is able to analyze the data based on type and attribute information of the extracted data and the user requirement.

Then, the analysis job generator 122 may define the extracted data and the extracted analysis algorithm to a job and include input and output variables and algorithm variables into the defined job to connect the data and the analysis algorithm with the job. The job may be transmitted to the analysis helper 121 and then further transmitted as recommendation analysis service information to the user through the interactive analytic tool 111.

The analysis job generator 122 may also transmit the job to the workflow generator 123 to provide more sophisticated analysis service.

The workflow generator 123 may generate analysis information using the received job and transmit the generated analysis information to the rule engine 134. For example, the workflow generator 123 may generate analysis information including big data system information and the user requirement in the keyword form by using information about the data and the analysis algorithm included in the job and the workflow scheduler 132.

The algorithm manager 124 may manage the stored analysis algorithms by being interconnected with a separate database which stores analysis algorithms.

The analytics workflow 131 may be an analysis processor suite composed of more than one job. For example, more than one job generated through the analysis job generator 122 may be tied to a minimum unit and analysis desired by the user may be then processed. Here, the workflow generator 123 may determine relationship between jobs and manage or modify where current analysis is processing.

The workflow scheduler 132 may perform directly to schedule and manage the big data platform and the workflow determined through the workflow generator 123.

The platform interface 133 may be an interface connecting the big data platform and the system for recommending data analysis services.

The rule engine 134 may receive and accumulate analysis information transmitted from the workflow generator 123 and generate a workflow corresponding to the user requirement using the accumulated analysis information. For example, the rule engine 134 may register the accumulated analysis information as a reference index which is needed to generate a workflow, and generate a workflow corresponding to the user requirement using the accumulated analysis information and study information of the analysis information.

The rule engine 134 may transmit the generated workflow to the analysis helper 121 and the analysis helper 121 may transmit the received workflow to the interactive analytic tool 111 to further transmit the workflow as recommendation analysis service information to the user.

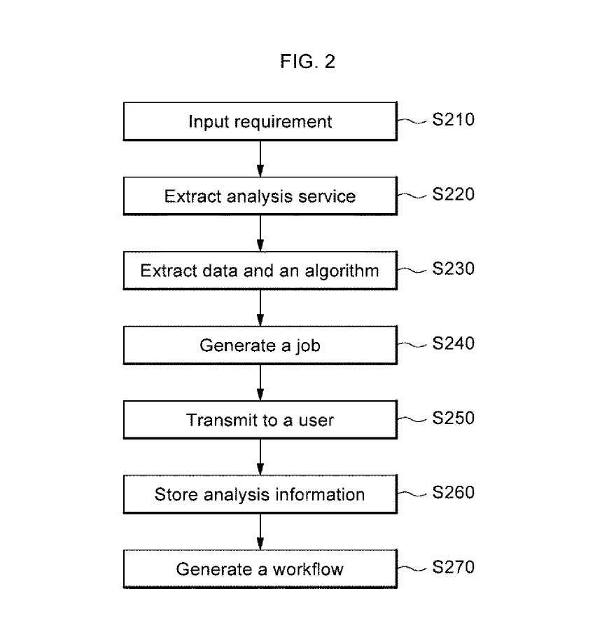

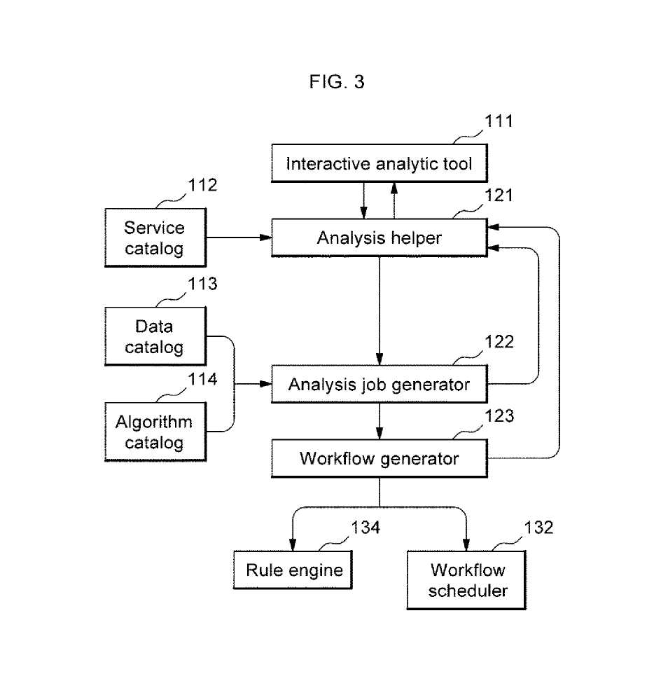

FIG. 2 is a flowchart illustrating a method for recommending data analysis services and FIG. 3 is a schematic view to explain the method for recommending data analysis services of FIG. 2. Data flow according to a method for recommending data analysis services may be determined in FIG. 3.

In S210, the interactive analytic tool 111 may receive a user requirement in a word or sentence form. The interactive analytic tool 111 may then convert the received user requirement into a keyword form through a parsing process and transmit the user requirement in the keyword type to the analysis helper 121.

In S220, the analysis helper 121 may extract an analysis service corresponding to the user requirement, received from the interactive analytic tool 111, from service catalog 112. The analysis helper 121 may transmit the user requirement in the keyword type to the analysis job generator 122.

In S230, the analysis job generator 122 may extract data and an analysis algorithm corresponding to the user requirement from the data catalog 113 and the algorithm catalog 114, respectively, based on the user requirement in the keyword type received from the analysis helper 121.

In S240, the analysis job generator 122 may define the extracted data and the extracted analysis algorithm to one job to generate a job by including input and output variables and algorithm variables into the defined job to connect the data and the analysis algorithm with the job.

In S250, the analysis job generator 122 may deliver the generated job to the analysis helper 121 to further deliver the job as recommendation analysis service information to the user through the interactive analytic tool 111. The analysis job generator 122 may also transmit the job to the workflow generator 123 to provide more sophisticated analysis service.

In S260, the workflow generator 123 may generate analysis information using the received job and transmit the generated analysis information to the rule engine 134. Then the rule engine 134 may accumulate the analysis information.

In S270, the rule engine 134 may generate a workflow corresponding to the user requirement using the accumulated analysis information. The rule engine 134 may transmit the generated workflow to the analysis helper 121 and the analysis helper 121 may transmit the received workflow to the interactive analytic tool 111 to further transmit the workflow as recommendation analysis service information to the user.

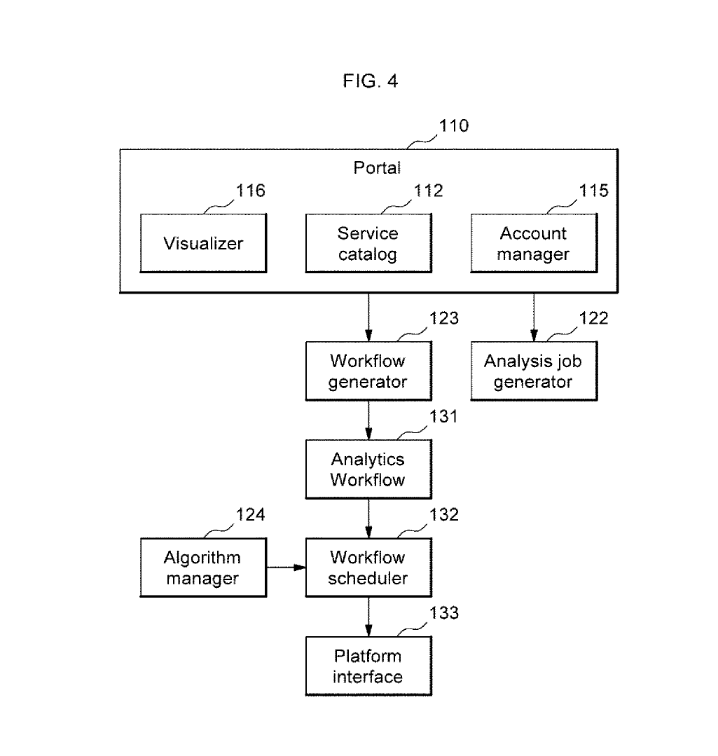

FIG. 4 is a method for providing an analysis service based on the selection of a recommendation analysis service.

Referring to FIG. 4, first, an analysis service may be recommended through understanding of user intention by using the service catalog 112. Second, a job with a pair of an analysis algorithm and data may be recommended by the analysis job generator 122. Third, a desired analysis service may be recommended through relation definition between jobs by the workflow generator 123.

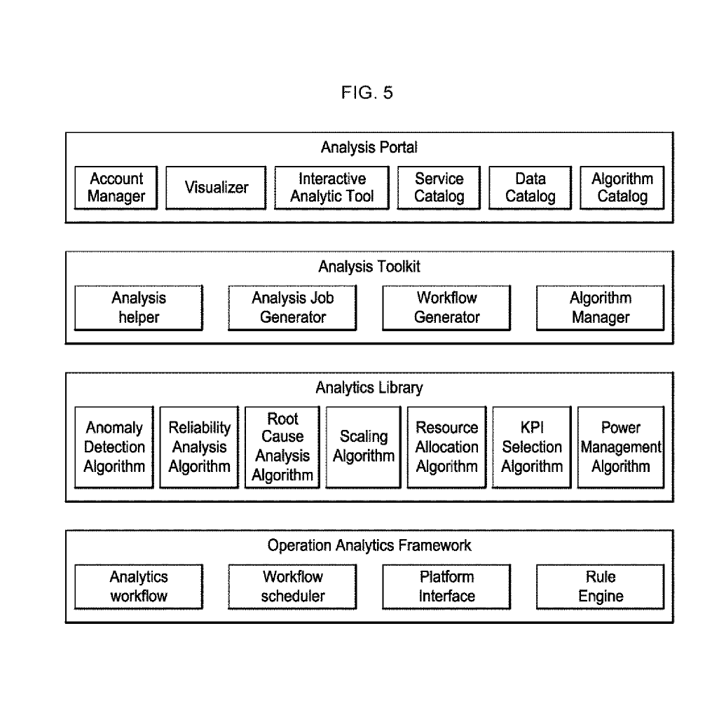

A system in which the system for recommending data analysis services according to an embodiment of the present invention is applied is shown in FIG. 5. FIG. 5 illustrates configuration of a log analysis system.

Accordingly, a method for recommending data analysis services according to an embodiment of the present invention may be implemented by a method implemented with a computer or by a non-volatile computer readable medium in which computer executable commands are stored. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents.

### DESCRIPTION OF REFERENCE NUMBERALS

110: Portal

111: Interactive analytic tool

112: Service catalog

113: Data catalog

114: Algorithm catalog

115: Account manager

116: Visualizer

120: Toolkit

121: Analysis helper

122: Analysis job generator

123: Workflow generator

124: Algorithm manager

130: Framework

131: Analytics workflow

132: Workflow scheduler

133: Platform interface

134: Rule engine

What is claimed is :

1. A system for recommending data analysis services:
a service catalog configured to store a list of analysis services;
a data catalog configured to store a list of data of targets for analysis;
an algorithm catalog configured to store a list of analysis algorithms;
an interactive analytic tool configured to receive a user requirement in a word or sentence form;
an analysis helper configured to receive the user requirement and extract an analysis service corresponding to the user requirement from the service catalog;
an analysis job generator configured to receive the user requirement, extract data and an analysis algorithm corresponding to the user requirement from the data catalog and the algorithm catalog, respectively, and define the extracted data and the extracted analysis algorithm to one job to generate a job,
wherein the analysis job generator transmits the generated job to the analysis helper to deliver the job as recommendation analysis service information to a user through the interactive analytic tool.

2. The system of claim 1, wherein the interactive analytic tool converts the received user requirement into a keyword form through a parsing process.

3. The system of claim 1, wherein the analysis job generator extracts the analysis algorithm based on type and attribute information of the extracted data and the user requirement.

4. The system of claim 1, wherein the analysis job generator includes input and output variables and algorithm variables into the defined job to connect the data and the analysis algorithm with the job.

5. The system of claim 1, further comprising:
a workflow generator configured to receive the job to generate analysis information; and
a rule engine configured to receive and accumulate the analysis information, generate a workflow corresponding to the user requirement based on the accumulated analysis information, and transmit the generated workflow to the analysis helper to further deliver the workflow as recommendation analysis service information to the user through the interactive analytic tool.

6. The system of claim 5, wherein the workflow generator generates the analysis information comprising big data system information and the user requirement in the keyword form by using information of the data and analysis algorithm included in the received job.

7. The system of claim 5, wherein the rule engine registers the accumulated analysis information as a reference index required for generating a workflow, and generates a workflow corresponding to current user requirement based on the accumulated analysis information and study information of the analysis information.

8. The system of claim 1, wherein when any one of the recommendation analysis service information is selected by the user, the selected recommendation analysis service is performed for an analysis operation in a big data platform.

9. A method for recommending data analysis services which is performed in a system for recommending data analysis services, the method comprising:
receiving a user requirement in a word or sentence form;
receiving the user requirement and extracting an analysis service corresponding to the user requirement from a service catalog, in which the service catalog stores a list of analysis services;
receiving the user requirement and extracting data and an analysis algorithm corresponding to the user requirement from a data catalog and an algorithm catalog, respectively, in which the data catalog stores a list of data of targets for analysis and the algorithm catalog stores a list of analysis algorithms;
defining the extracted data and the extracted analysis algorithm to one job to generate a job; and
transmitting the generated job as recommendation analysis service information to a user.

10. The method of claim 9, wherein the step for receiving a user requirement comprises converting the received user requirement into a keyword form through a parsing process.

11. The method of claim 9, wherein the step for extracting data and an analysis algorithm corresponding to the user requirement comprises extracting the analysis algorithm based on type and attribute information of the extracted data and the user requirement.

12. The method of claim 9, wherein the step for generating a job comprises including input and output variables and algorithm variables into the defined job to connect the data and the analysis algorithm with the job.

13. The method of claim 9, further comprising:
receiving the job to generate analysis information;
receiving and accumulating the analysis information;
generating a workflow corresponding to the user requirement based on the accumulated analysis information; and
transmitting the generated workflow as recommendation analysis service information to the user.

14. The method of claim 13, wherein the step for generating analysis information comprises generating the analysis information comprising big data system information and the user requirement in the keyword form by using information of the data and analysis algorithm included in the received job.

15. The method of claim 13, wherein the step for generating a workflow comprises registering the accumulated analysis information as a reference index required for generating a workflow, and generating a workflow corresponding to current user requirement based on the accumulated analysis information and study information of the analysis information.
